(19) United States
(12) Patent Application Publication
(10) Pub. No.: US 2026/0342387 A1
(43) Pub. Date: Oct. 29, 2026

(54) Method of Forming a D-MIMO Arrangement in a Communication Network

(71) Applicant: Telefonaktiebolaget LM Ericsson (publ), Stockholm (SE)

(72) Inventors: Athanasios Karapantelakis, Voula (GR); Hossein Shokri Ghadikolaei, Täby (SE); Lackis Eleftheriadis, Valbo (SE); Oleg Gorbatov, Luleå (SE); Kaushik Dey, Kolkata (IN)

(21) Appl. No.: 19/486,100

(22) PCT Filed: Sep. 27, 2023
(86) PCT No.: PCT/SE2023/050946

§ 371 Date: Nov. 20, 2025

(30) Foreign Application Priority Data
May 29, 2023 (GR) 20230100426

(51) Int. Cl. H04B 7/0413

(52) U.S. Cl. CPC H04B 7/0413

(57) ABSTRACT

According to an aspect, there is provided a computer-implemented method of forming a Distributed-Multiple Input, Multiple Output, D-MIMO, arrangement in a communication network. The method comprises: obtaining (301) movement information relating to movement of mobile antenna, MA, devices (103; 113) in the communication network; determining (303), from the movement information, one or more of the MA devices (103; 113) that can operate as a Transmission and/or Reception Point, TRP, in the D-MIMO arrangement; and sending (305) a first control signal to the determined one or more MA devices (103; 113) to instruct the one or more MA devices (103; 113) to operate as a TRP in the D-MIMO arrangement.

### TECHNICAL FIELD

This disclosure relates to Distributed-Multiple Input, Multiple Output (D-MIMO) arrangements in a communication network, and in particular relates to techniques for forming a D-MIMO arrangement.

### BACKGROUND

Multiple Input Multiple Output (MIMO) is a technology that increases capacity of a radio link using arrays of reception (Rx) and transmission (Tx) antennas, also known as Transmission and Reception Points (TRPs). Distributed MIMO (D-MIMO) uses multiple logical antennas that can be spatially distributed. D-MIMO has some advantages over co-located MIMO, such as addressing interference, loss of line of sight (LoS) problems and further enhancing capacity by taking advantage of multiple physical antennas.

D-MIMO is particularly intended for indoor use or use in hotspots in dense environments, and also overcomes the limitation of conventional indoor or “small cell”-type TRPs that use a limited number of antennas in their antenna arrays due to size, cost and weight constraints (typically 4 Rx and 4 Tx antennas per TRP).

One disadvantage of D-MIMO is that it requires radio access network (RAN) planning a-priori, as well as strategic placement of TRPs to provide coverage matching the demand for mobile data traffic. Specifically, the disadvantages of stationary D-MIMO can be further analysed as:
First, given that traffic patterns are seasonal/temporal (e.g. they may vary during the time of day, the day of the week, the date, or month/year), it can be the case that many of the TRPs become underutilised for at least some of the time. This means additional cost, both Operational Expenses (OPEX) in terms of TRP maintenance, power feed, etc, and Capital Expenses (CAPEX) in terms of purchasing additional TRPs to cover all “blind spots” or spots of peak demand. Another cost dimension may come from new regulations relating to the existing battery on every site, which should keep the network alive (active) for some predetermined number of hours in the event of a mains power failure. This implies battery dimensioning (capacity selection) based on the peak traffic, while the majority of the time the traffic may be much smaller, so the battery could be much smaller, which saves CAPEX, especially when aiming for a dense deployment of TRPs.
Second, given a change in traffic patterns, the mobile network may need to be re-dimensioned, which means additional cost for removing or installing TRPs in new locations, not to mention the potentially long delays to get the permissions and install a static TRP.
Third, static TRPs may not be suitable for covering temporary hot spots.

### SUMMARY

Certain aspects of the disclosure and their embodiments may provide solutions to these or other challenges.

In this disclosure it is considered that TRPs can be mobile and can be tasked to specific areas to serve mobile traffic based on predicted demand. This can be coordinated by a centralised control node (which can, for example, be hosted in an edge cloud, or a macro-base station (BS)). Alternatively, decentralised coordination among a set of TRPs can be used to identify areas which need better support by mobile TRPs. The solution provided this disclosure is referred to as Mobile D-MIMO (MD-MIMO). The MD-MIMO solution is not mutually exclusive to legacy stationary D-MIMO, and allows for a certain percentage of the TRPs to be stationary.

Briefly, this disclosure provides a control method for temporary tasking of one or more mobile antennas (MAs)—also referred to as MA devices herein—which may have a pre-planned mission/task, to serve as TRPs, given a (predicted) need to do so. More specifically, according to the techniques described herein, a control method determines when a TRP will be switched on and start to serve a user equipment (UE) or base station in the area, given movement of that TRP (e.g. a pre-planned trajectory). This activation of the MA as a TRP can be based on a prediction of data traffic demand. Similarly, the control method determines when the TRP is to be switched off, thus saving energy/battery.

In some embodiments, the control method can also control the movement of the TRP in addition to predicting when to switch it on, given a predicted traffic demand. In some embodiments, consideration is given to a UE also temporarily becoming a TRP, for example using 5^{th} Generation (5G) Integrated Access and Backhaul (IAB) technology.

The techniques described herein are of particular interest to enterprise networks (e.g. private 5G), where the enterprise typically owns/manages both mobile network equipment and UEs. In this use case there can be a higher degree of predictability about the traffic patterns of mobile traffic and mobilities (movement) over the day. MAs that can operate as TRPs can be logically embedded in Automated Guided Vehicles (AGVs), such as logistics robots, that already serve another primary purpose (e.g. transporting goods in a warehouse environment).

Another use case could also consider public networks, for example where Unmanned Aerial Vehicles (UAVs) such as drones, have been temporarily tasked to cover an area, e.g., during emergency situations such as accidents, man-made or natural disasters. Another option is to create a temporary network in scenarios in which building infrastructure to run only for a short amount of time may not be economically viable, and the network operator may prefer to rent some UAVs instead. The techniques are also of interest to other use cases or deployment scenarios.

According to a first aspect, there is provided a computer-implemented method of forming a D-MIMO arrangement in a communication network. The method comprises obtaining movement information relating to movement of mobile antenna, MA, devices in the communication network; determining, from the movement information, one or more of the MA devices that can operate as a TRP in the D-MIMO arrangement; and sending a first control signal to the determined one or more MA devices to instruct the one or more MA devices to operate as a TRP in the D-MIMO arrangement.

According to a second aspect, there is provided a method of operating a first MA device. The first MA device comprising an antenna and a communication interface that are selectively operable to enable the first MA device to operate as a TRP in a D-MIMO arrangement. The method comprising: receiving a first control signal, wherein the first control signal instructs the first MA device to operate as a TRP when the first MA device is at one or more respective locations and/or when moving along a respective path; and operating the antenna and communication interface to enable the first MA device to operate as a TRP when the first MA device is at the one or more respective locations and/or when the first MA device is moving along the respective path.

According to a third aspect, there is provided a computer program product comprising a computer readable medium having computer readable code embodied therein, the computer readable code being configured such that, on execution by a suitable computer or processor, the computer or processor is caused to perform the method according to the first aspect, the second aspect, or any embodiments thereof.

According to a fourth aspect, there is provided a network node configured to perform the method according to the first aspect or any embodiment thereof.

According to a fifth aspect, there is provided a first MA device configured to perform the method according to the second aspect or any embodiment thereof.

According to a sixth aspect, there is provided a network node comprising a processor and a memory, said memory containing instructions executable by said processor whereby said control module is operative to perform the method according to the first aspect or any embodiment thereof.

According to a seventh aspect, there is provided a first MA device comprising a processor and a memory, said memory containing instructions executable by said processor whereby said first MA device is operative to perform the method according to the first aspect or any embodiment thereof.

Certain embodiments may provide one or more of the following technical advantage(s). For example, the techniques can reduce the number of stationary TRPs to be used when deploying the network, resulting in reduced capital and operational expenditures (CAPEX/OPEX). As another example, the need for extensive network planning can be reduced, which is also a cost. In the case of an AGV-related deployment, the cost associated with network planning can be focussed on areas not covered by AGVs. Linked to this cost are network upgrade costs, to provide additional coverage. Instead of manual network planning, the disclosed control method will automatically task MAs fulfil the requirements. In this respect, more MAs (e.g. AGVs) can be procured, and the control method will automatically task them to operate as TRPs as required. Another advantage is that the techniques provide for easier network dimensioning and agile demand response. Another advantage is that, by using mobile TRPs, temporary hot spots can be supported, and the antennas can be closer to the UEs, which increases their Quality of Service (QoS), and reduces the energy consumption of the network.

### BRIEF DESCRIPTION OF THE DRAWINGS

Some of the embodiments contemplated herein will now be described more fully with reference to the accompanying drawings, in which:

FIG. 1(a) illustrates a centralised approach for implementing the control module, and FIG. 1(b) illustrates a distributed approach;

FIG. 2 illustrates an exemplary set of inputs to the control module and an exemplary output;

FIG. 3 is a flow chart illustrating a method of forming a D-MIMO arrangement according to various embodiments;

FIG. 4 is a flow chart illustrating a method of operating a first MA device according to various embodiments;

FIG. 5 illustrates a learning phase for the control module based on deep reinforcement learning;

FIG. 6 illustrates an input to the control module in the form of a three-dimensional spatial map;

FIG. 7 illustrates operation of the control module according to various embodiments;

FIG. 8 shows an example of a communication system in accordance with some embodiments;

FIG. 9 shows a UE in accordance with some embodiments;

FIG. 10 shows a RAN network node in accordance with some embodiments;

FIG. 11 shows a core network node in accordance with further embodiments; and

FIG. 12 is a block diagram illustrating a virtualization environment in which functions implemented by some embodiments may be virtualized.

### DETAILED DESCRIPTION

Some of the embodiments contemplated herein will now be described more fully with reference to the accompanying drawings. Embodiments are provided by way of example to convey the scope of the subject matter to those skilled in the art.

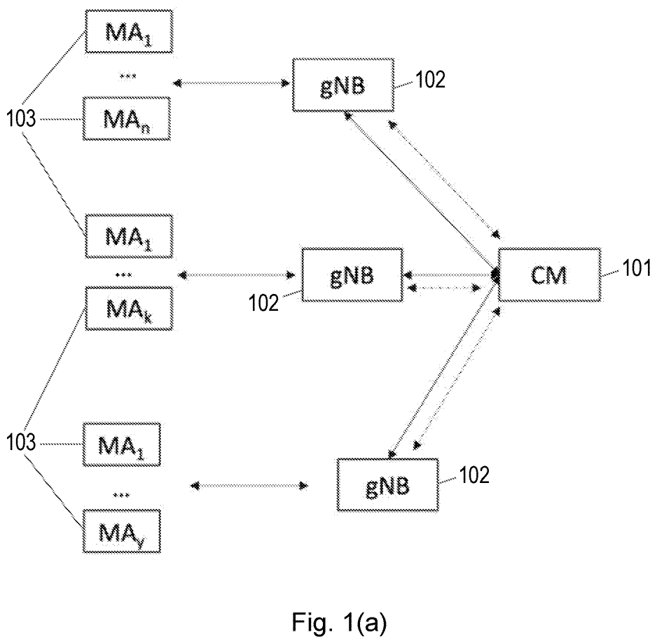

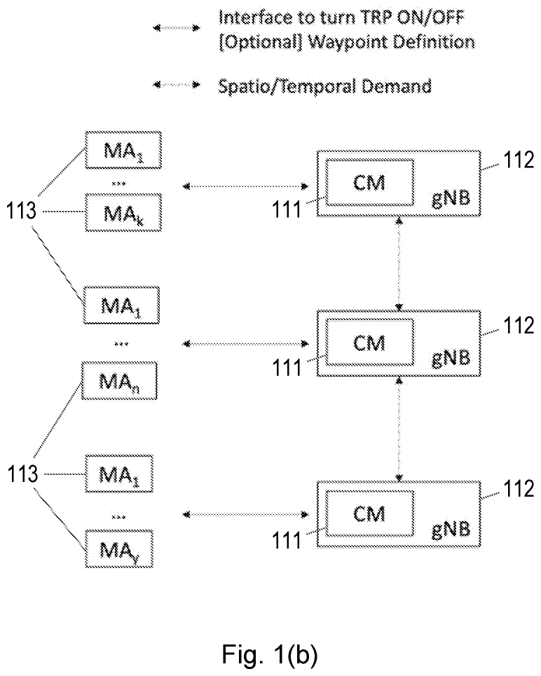

As noted above, this disclosure presents a MD-MIMO arrangement in which at least some of the TRPs can be mobile (i.e. move through the environment) and can be tasked to specific areas to serve user/data traffic based on predicted demand. This can be coordinated by a centralised control node (which can, for example, be hosted in an edge cloud, or a macro-base station (BS)), and is illustrated in FIG. 1(a). Alternatively, decentralised coordination can be used, as illustrated in FIG. 1(b).

The D-MIMO arrangement can be for a radio access network (RAN) node (e.g. a gNB), i.e. the TRPs in the D-MIMO arrangement can be used to improve transmission of user/data traffic by the RAN node to one or more UEs in the communication network, and/or to improve reception of user/data traffic by the RAN node from one or more UEs. Alternatively, the D-MIMO arrangement can be for a UE, i.e. the TRPs in the D-MIMO arrangement can be used to improve transmission of user/data traffic by the UE to a RAN node in the communication network, and/or to improve reception of user/data traffic by the UE from a RAN node.

FIG. 1(a) shows a control module 101, several radio access network (RAN) nodes 102, e.g. gNBs, and several mobile antennas (MAs) 103 in a communication network. The UE(s) that may transmit/receive traffic to/from the RAN nodes 102 are not shown in FIG. 1(a).

In this centralised approach, the control module 101 may be implemented in the core network of the communication network (e.g. in an existing core network node, or a new type of core network node), or the control module 101 can be implemented in one of the RAN nodes 102 in the RAN of the communication network (provided that the control module 101 can interface with the other RAN node 102). In either case, the control module 101 performs the method described herein to determine which, and when, certain MAs 103 are to be operated as TRPs for a D-MIMO arrangement.

The control module 101 is able to send control signals to the MAs 103 via the relevant RAN nodes 102 (as indicated by the solid arrows) to control the activation of the MA 103 as a TRP, and subsequent deactivation. Optionally, the RAN nodes 102 may provide traffic load information (indicated by the dashed arrows) to the control module 101 to enable the control module to take traffic load into account when determining whether additional TRPs are required or useful.

FIG. 1(b) shows respective control modules 111 implemented as part of respective RAN nodes 112, e.g. gNBs, and several MAs 113. The UE(s) that may transmit/receive traffic to/from the RAN nodes 102 are not shown in FIG. 1(b).

In this decentralised approach, the control modules 111 in the respective RAN nodes 112 exchange information with each other (e.g. load information), and each control module 101 determines whether certain MAs 113 are to be operated as TRPs for a D-MIMO arrangement for the respective RAN node 112.

Each control module 111 is able to control their respective RAN node 112 to send control signals to the MAs 113 (as indicated by the solid arrows) to control the activation of the MA(s) 113 as a TRP, and subsequent deactivation.

Although not shown in FIG. 1(a) or (b), one or more stationary antennas (SAs) can be present in the communication network and used as TRPs by one or more of the RAN nodes or UEs. Typically these SAs will be permanently activated as TRPs.

The mobile antennas (MAs) are mobile entities-in the sense that they are able to move around in the environment and are not at fixed location—that have the capability to function as TRPs. The TRP function does not have to be always on and can be switched on or off, on-demand, by the control module 101/111. A MA comprises at least an antenna and a communication interface/radio circuitry that enables the MA to receive radio signals and repeat (i.e. retransmit) those radio signals. In some embodiments, the MA can be a selectively activatable mobile TRP, i.e. the MA is provided for the purpose of being activated as a TRP when required.

In other embodiments, a MA can be a User Equipment (UE). The UE may be present in the communication network for its own purposes (e.g. it is owned and used by a subscriber), but can be activated as a TRP when conditions allow (e.g. when the subscriber is not itself using the UE). Alternatively, the MA can be UE that is present in the communication network specifically for the purpose of being selectively activated to operate as a TRP. In some embodiments, the UE may have the capability to function as an Integrated Access and Backhaul (IAB) node.

In some embodiments, a MA can be a mobile small cell, already having connectivity to the network but also means to be mobile (i.e. move).

It will be appreciated that the MAs 103/113 available in the communication network can be a mix of different types, e.g. a mix of simplified UEs, UEs, mobile small cells, etc.

MAs 103/113 may have a fixed trajectory/path through the environment, for example in the case where the MA is part of an industrial robot or vehicle. Alternatively, the MA could be tasked to move to a specific location/waypoint (or list of waypoints). MAs 103/113 may have a primary function or “mission”, for example to deliver cargo to a certain destination. The primary function or mission may have some tolerance intervals (in terms of time and processing load) that must be respected in case the MA 103/113 is also chosen by the control module 101/111 to function as a TRP. In this case, the control module 101/111 may be limited to using those predefined routes, and potentially corresponding preliminary timetables as the mobility patterns, of MAs to activate/deactivate them as TRPs. For example, a cargo vehicle or bus that takes a predefined path according to a predefined timetable can be controlled to act as a TRP when it approaches a certain area on a certain time of the day, for example based on the predicted traffic loads.

Where the MA 103/113 does not have a primary function or mission, or it does have a primary function or mission but with a relaxed requirement on the path taken and/or timetable, the control module 101/111 can have more flexibility to optimise the route of the MA so it can more effectively operate as a TRP.

The control module 101/111 determines when to switch the TRP mode on and off in the MAs 103/113. The control module 101/111 can be a logical function that implements a control method, and can be centralised (e.g. located in the core network as shown in FIG. 1(a)), or can be distributed (e.g. across multiple macro cells covering a specific area as shown in FIG. 1(b)). The control module 101/111 decision process can be trigged by a prediction of future load at different gNBs, for example an indication of high load on at least one of these gNBs.

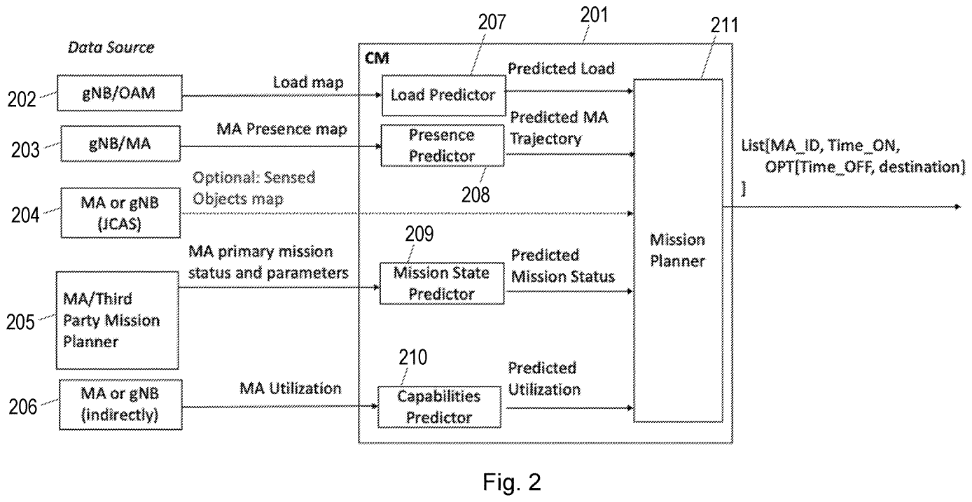

FIG. 2 illustrates an exemplary set of inputs to a control module 201, some internal processing (predictor) modules, and an exemplary output. FIG. 2 shows a planner-based approach to the control module 201.

In this illustrated example, the control module 201 receives one or more of the following types of information or data from a number of different information/data sources.

Information about the traffic load, optionally in the form of a load map, can be provided by a RAN node 202 (such as a gNB) or Operations Administration and Maintenance (OAM) node 202. MA presence information, optionally in the form of a presence map, can be provided by a RAN node 203 or MA 203. Sensed objects information, optionally in the form of a sensed objects map, can be provided by a MA or RAN node 204. The sensed objects information can be determined using a suitable sensing technique, such as Joint Communications and Sensing (JCAS). MA ‘primary mission’ status and/or parameters can be provided by a MA 205 or a mission planner module 205 (which is typically operated by a third party). MA utilisation information can be provided by a MA or RAN node 206.

A load map can spatially indicate the current load in the communication network. This load map can be provided by the RAN node/gNB 202, as it already has the relevant Performance Monitoring (PM) counters. Another potential source of this information could be the OAM core network node 202.

A MA presence map can indicate the current location of MAs. This can be provided by the RAN node/gNB 203 which knows its location, but can also estimate the distance of every MA from its location using a technique such as JCAS or 5G positioning, or another technology. Alternatively, or in addition, the MA 203 can provide this information, e.g. using an over-the-top location technology such as satellite positioning. The presence map may also be augmented by parameters such as the heading and velocity of each MA 203. The presence can be also time-stamped.

An obstacle map, i.e., the indication of obstacles in space that are sensed by the mobile network, can be determined using a technology such as Joint Communication and Sensing (JCAS) that will be made possible with the high frequencies that future gNBs (e.g. 6^{th} Generation (6G)) are expected to operate in. Alternatively, information from sensors typically mounted in AGVs can also be used to provide the obstacle information (e.g. Light Detection and Ranging (LIDAR) type of sensors).

The MA ‘primary mission’ status and/or parameters which can indicate the current mission/task of each MA can be provided as a list of waypoints (i.e. waypoints that the MA will be at during the mission/task), as well as the percentage of the mission that has been completed, including mission margins, expressed, e.g., in terms of time. Mission margin refers to how much additional time the MA can afford to expend in other activities without harming the objective of the mission/task. Such parameters can be retrieved from the MA's internal planning software, or via a third-party mission planner 205. In some cases, such systems 205 may reside within a network operations center (NOC).

The MA utilisation information can be a set of metadata for every MA 103/113 that includes its current mission parameters and progress, and also/alternatively its capabilities in terms of compute, memory, and bandwidth.

The traffic load information is provided to a load predictor/prediction module 207 in the control module 201 that can process the traffic load information to predict the traffic load at some future time point, e.g. 5, 10, 20, 30, 60 minutes from the time of prediction is made.

The MA presence map can be provided to a presence predictor/prediction module 208 in the control module 201 that can process the information in the presence map to predict the trajectory of the MA(s).

The MA ‘primary mission’ status and/or parameters can be provided to a mission state predictor/prediction module 209 in the control module 201 that can process the mission status and/or parameters to predict the mission status of the MA(s).

The MA utilisation information can be provided to a capabilities predictor/prediction module 210 in the control module 201 that can predict the utilisation of the MA(s).

Each of the above optional predictions, and the optional sensed objects map can be provided to a mission planner module 211 in the control module 201. The mission planner module 211 evaluates/analyses the predictions to determine which MAs can be activated as TRPs, and when those MAs can be activated as TRPs. The mission planner module 211 outputs an indication of one or more MAs that are to be activated as TRPs. This output can be in the form of a list, with entries in the list identifying any of: a specific MA (e.g. MA_ID), a time that the specific MA is to operate as a TRP (e.g. Time_ON), a time that the specific MA is to stop operating as a TRP (e.g. Time_OFF), and a position/location/destination for the MA to be heading towards or to be at to operate as a TRP.

Briefly, a D-MIMO arrangement can be formed using the following procedure/steps.

In an initial background/learning phase, the control module 201 can use the one or more predictors 207, 208, 209, 210 to provide future predictions based on any of: the load of the network, the location, and/or MA utilisation. It is possible for the predictions to concern multiple time points in the future (e.g. 5, 10, 20, 30, 60 minutes from the time of prediction) and can technically be implemented using trained models created by standard machine learning tools and algorithms (e.g. regression or deep learning-based sequence-to-sequence recurrent neural networks, etc.). In the distributed case, every control module 201 can train its own predictor(s) 207-210 only for a specific area (i.e. based on the range of the gNB 112 the control module 201 is responsible for).

In a first step, which can be performed once the predictor(s) 207-210 have all reached a level of acceptable accuracy and/or when a future load is predicted that is beyond the current capability to cover, the control module 201 can trigger a process to task one or more MAs 103/113 to operate as TRPs (i.e. turn on their TRP components, if not otherwise active), and optionally move to a designated position/location. This first step of the process can involve retrieving predictions from the utilisation/capabilities predictor 210, indicating how much each TRP will be utilised, and where it will be located at the time of the predicted load event. In addition, the mission state predictor 209 can be used to provide information about the status and margins of the mission of each MA/TRP at the time of the load event. Optionally, the sensed objects map may be used as it indicates the presence of obstacles.

In a second step, the output of the predictors 207-210 is input to mission planner 211, optionally together with the sensed obstacles (as indicated by the sensed objects map). The mission planner 211 can set a goal condition to move one or more MAs with the capacity to function as TRPs (based on their predicted utilisation), to the correct location, and within margin of their primary mission. The mission planner 211 can simulate different scenarios until it identifies one that fulfils the goal condition. The mission can be defined using, for example, Planning Domain Definition Language (PDDL), and can be simulated using one of the widely available PDDL-based simulators. Alternatively, a deep learning approach may be used, which is described further below. It will be appreciated that the mission planner 211 can set other goal conditions to that set out above, or variations of the goal condition set out above.

Based on the scenario returned by the mission planner 211, one or more MAs are tasked to turn on their TRP capability, potentially at a specific point in time in the future. In some embodiments, the mission planner 211/control module 201 can task the MA to move to a specific position/location/destination to operate as the TRP, and then re-task it to its primary mission (to make sure the primary mission is completed according to its requirements), based on the prediction of the duration of the load event.

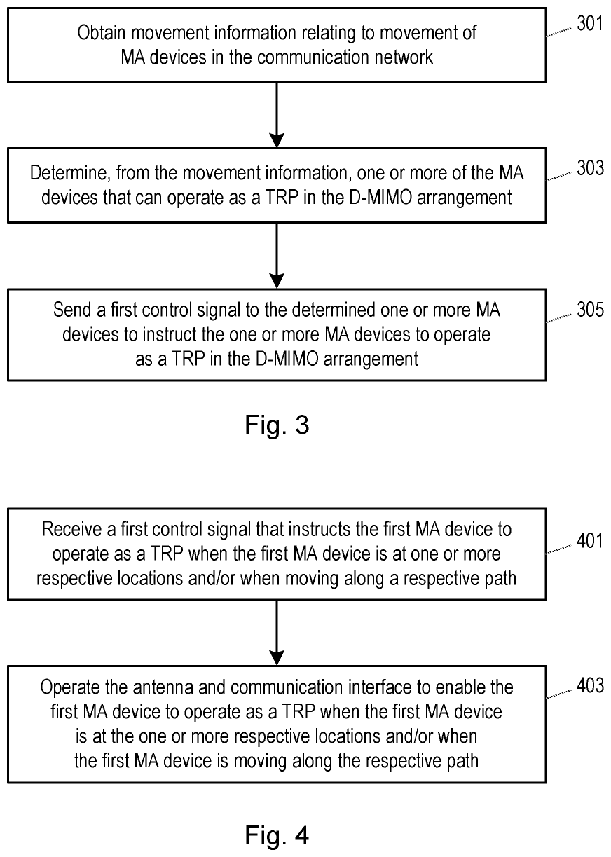

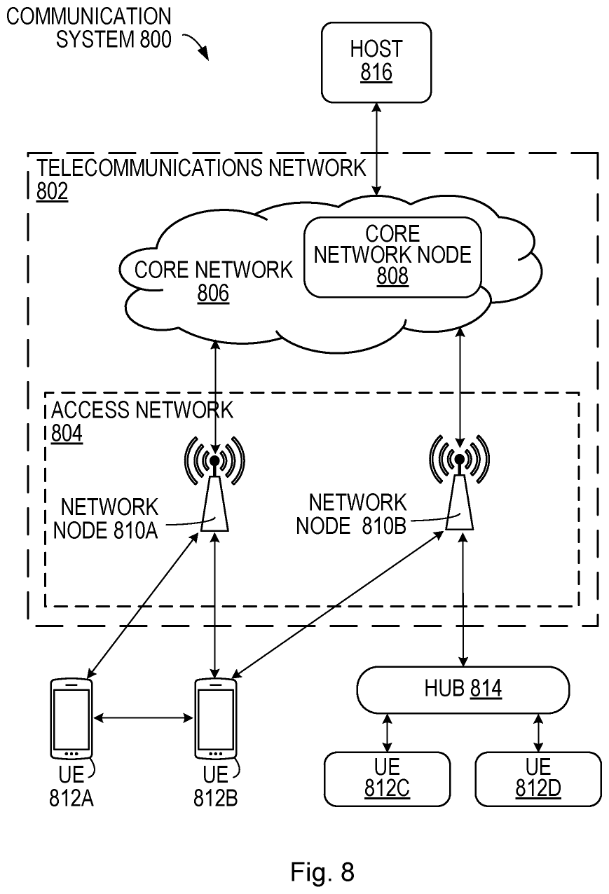

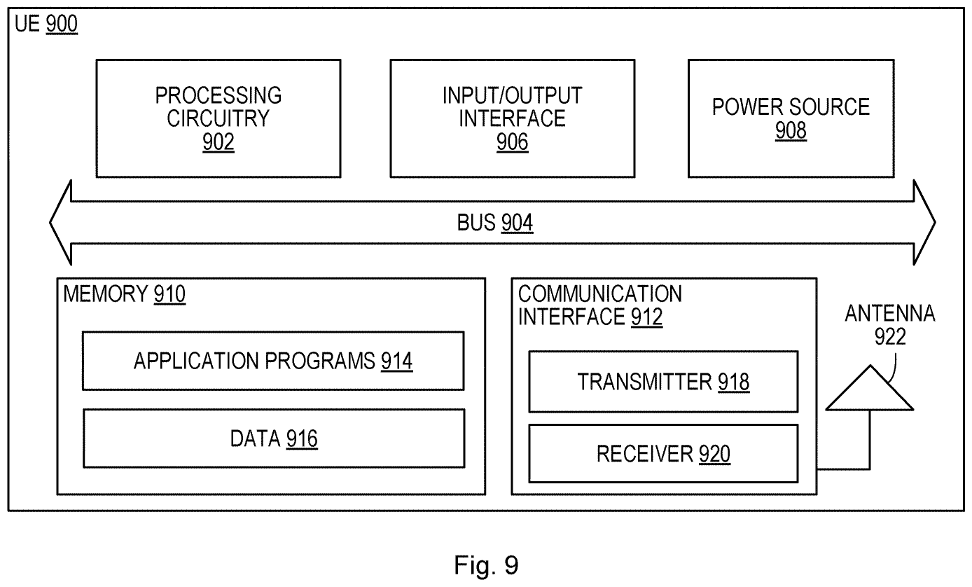

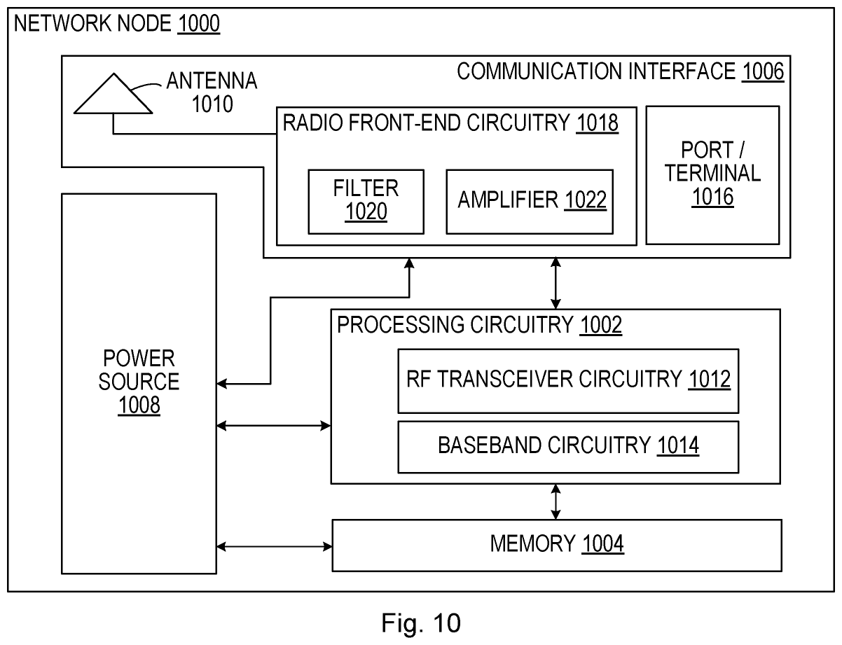

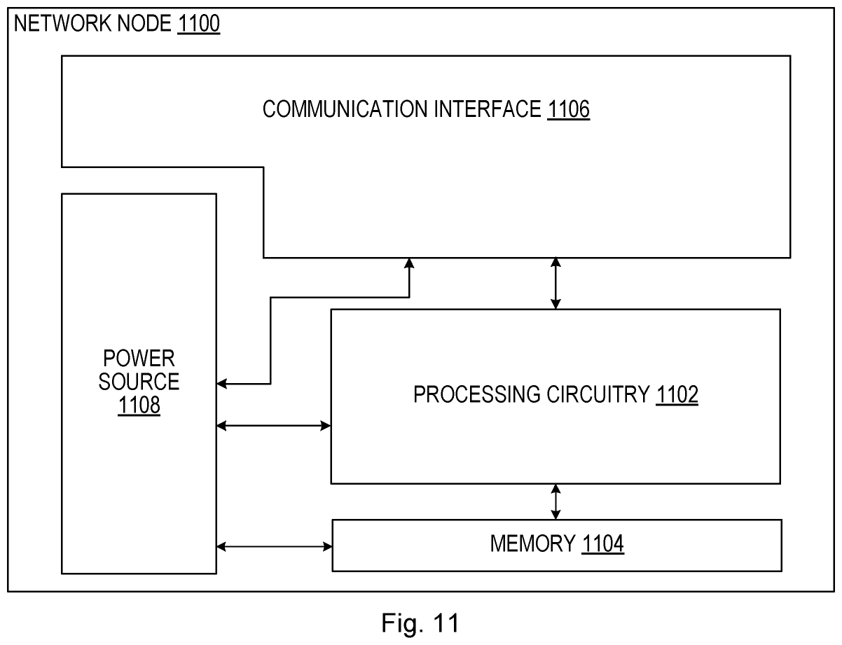

The flow chart in FIG. 3 illustrates a method of forming a D-MIMO arrangement in a communication network according to various embodiments. This method can be performed by a computer, or any suitable type of network node in a communication network. For example, as described above, the method can be performed by a control module 101/111/211 that is part of a network node, by a RAN node 102/112 (e.g. a RAN node 810 in FIG. 8, or RAN node 1000 in FIG. 10), by a core network node in the core network of the communication network (e.g. core network node 808 in FIG. 8, or core network node 1100 in FIG. 11) or by a UE (e.g. UE 812 in FIG. 8 or UE 900 in FIG. 9). The method in FIG. 3 can be performed in response to executing suitably formulated computer readable code. The computer readable code may be embodied or stored on a computer readable medium, such as a memory chip, optical disc, or other storage medium. The computer readable medium may be part of a computer program product.

In step 301, movement information relating to movement of MA devices in the communication network is obtained. A MA device may be a UE, or any device that has suitable antenna(s) and communication interface/radio circuitry that enables the MA device to operate as a TRP. For example, the MA device can be an industrial vehicle, an industrial robot, a general use vehicle (e.g. lorry, car, van, etc.), a drone or UAV, etc.

The movement information can comprise any suitable type of information relating to the movement or planned movement of a MA device. For example, the movement information can comprise a planned movement route for the MA device, i.e. a route along which the MA device is to move, for example when performing a mission or task assigned to the MA device. The movement information can also or alternatively comprise one or more waypoints that the MA device is to move to over time, for example during performance of a mission or task assigned to the MA device. The movement information can also or alternatively comprise a predicted movement trajectory that is predicted based on current movement of the MA device. That is, the movement trajectory can be predicted based on a current speed and heading of the MA device, and optionally based on the locations of obstacles or objects in the environment. The movement information can also or alternatively comprise timing information relating to the movement of the MA device, for example indicating when the MA device is to move, and/or time(s) at which the MA device may be at certain location(s).

In step 303, one or more of the MA devices are determined that can operate as a TRP in the D-MIMO arrangement. These MA devices are determined from the movement information.

In step 305, a first control signal is sent to the determined one or more MA devices to instruct the one or more MA devices to operate as a TRP in the D-MIMO arrangement. This first control signal can be sent directly to the MA device(s), e.g. in the case where the method is performed in a RAN node or UE, or the first control signal can be sent indirectly via one or more other nodes, e.g. in the case where the method is performed in a core network node the first control signal can be sent via a RAN node.

In some embodiments, the D-MIMO arrangement comprises a UE and is used by the UE to transmit signals to, and/or receive signals from, a RAN node (e.g. a gNB).

In other embodiments, the D-MIMO arrangement comprises a RAN node (e.g. a gNB) and is used by the RAN node to transmit signals to, and/or receive signals from, one or more UEs.

In some embodiments, prior to step 303, a traffic demand can be estimated, and step 303 can be performed in response to the estimated traffic demand. In particular, step 303 can be performed if the estimated traffic demand is above a threshold value. The threshold value can be related to a traffic capacity of the communication network or traffic capacity of part of the communication network in which the MA device is located.

In some embodiments, the first control signal can also indicate a respective time at which the determined MA devices are to operate as a TRP.

In some embodiments, prior to step 303, a future traffic demand can be predicted, and step 303 can be performed in response to the predicted future traffic demand. In this case, the first control signal can indicate a respective time related to the predicted future traffic demand at which the determined MA devices are to operate as a TRP.

In some embodiments, the first control signal indicates that the one or more MA devices are to move to a respective location or move along a respective path in order to operate as a TRP for the D-MIMO arrangement. In this way, the method controls the MA devices to move to a suitable (or better) location in order to operate as a TRP. In these embodiments, the method can further comprise determining a respective location for the one or more MA devices to move to and/or a respective path for the one or more MA devices to move along. This determining step can be based on a prediction of one or more locations at which a TRP is useful for the D-MIMO arrangement.

In some embodiments, the first control signal indicates that the one or more MA devices are to operate as a TRP for the D-MIMO arrangement when at one or more respective locations and/or when moving along a respective path.

In some embodiments, the method also comprises sending a second control signal to the determined one or more MA devices to instruct the one or more MA devices to stop operating as a TRP. The second control signal can be sent at the time that the one or more MA devices are to stop operating as a TRP, or it can be sent ahead of that time, with the second control signal indicating a time at which the MA device(s) are to stop operating as a TRP. In some embodiments, the second control signal is sent in response to an estimated traffic demand, for example when the estimated traffic demand is below a threshold value. That is, MA devices can be instructed to stop operating as TRPs when the traffic demand decreases sufficiently.

In some embodiments, step 303 comprises using a machine learning (ML) model, with the movement information provided as an input to the ML model. The ML model may further receive any of: an estimated traffic demand (e.g. from a predictor 207), a predicted future traffic demand (e.g. from a predictor 207), capability information for the one or more MA devices (e.g. from a predictor 210), and obstacle information relating to a presence of obstacles in an environment in which the one or more MA devices are located.

The flow chart in FIG. 4 illustrates a method of operating a first MA device according to various embodiments. The first MA device comprises at least one antenna and a communication interface/radio circuitry that are selectively operable to enable the first MA device to operate as a TRP in a D-MIMO arrangement. The first MA device may be a UE, or any device that has suitable antenna(s) and communication interface/radio circuitry that enables the MA device to operate as a TRP. For example, the MA device can be an industrial vehicle, an industrial robot, a general use vehicle (e.g. lorry, car, van, etc.), a drone or UAV, etc. Thus, the method in FIG. 4 can be performed by a UE (e.g. UE 812 in FIG. 8 or UE 900 in FIG. 9), including UE 900 that only includes antenna 922 and communication interface 912. The method in FIG. 4 can be performed by processing circuitry in a first MA device (e.g. processing circuitry 902 in the UE 900 of FIG. 9) in response to executing suitably formulated computer readable code. The computer readable code may be embodied or stored on a computer readable medium, such as a memory chip, optical disc, or other storage medium. The computer readable medium may be part of a computer program product.

In step 401, the first MA device receives a first control signal. The first control signal instructs the first MA device to operate as a TRP when the first MA device is at one or more respective locations and/or when moving along a respective path.

In step 403, the first MA device operates the antenna and radio circuitry to enable the first MA device to operate as a TRP when the first MA device is at the one or more respective locations and/or when the first MA device is moving along the respective path.

In some embodiments, the first control signal also indicates a time at which the first MA device is to operate as a TRP. In this case, step 403 can be performed at the indicated time.

In some embodiments, the first control signal further instructs the first MA device to move to a location or move along a path in order to operate as a TRP for the D-MIMO arrangement. In these embodiments, prior to step 403, the method can further comprise the first MA device moving to the indicated location or moving along the indicated path. Step 403 can be performed when the first MA device is at the indicated location or when the first MA device is moving along the indicated path. In these embodiments the first MA device has the capability to move around the environment, for example autonomously (i.e. without requiring operational input by a user).

In some embodiments, the first MA device can receive a second control signal that instructs the first MA device to stop operating as a TRP. In this case, the first MA device can stop operating as a TRP. In some embodiments, the second control signal can indicate a time at which the first MA device is to stop operating as a TRP, in which case the first MA device stops operating as a TRP at the indicated time.

One specific approach for the control module 101/111/201 to determine the MA device(s) that are to serve/operate as TRPs is a symbolic approach based on a planner, which first formalises the input as a planning problem, setting up an initial state, agents and their parameters, simulation space and goal conditions. This planner-based approach is suited for less complex environments (e.g. a low number of possible MA devices) and has a disadvantage that there is no learning involved. Instead, simulations must be run every time a decision is to be made.

An alternative approach for the control module 101/111/201 to determine the MA device(s) that are to serve/operate as TRPs is based on deep reinforcement learning that uses an agent to learn to task based on a reward. The deep learning-based embodiment is better suited for more complex environments with many AGVs (e.g. hundreds or thousands) but has a disadvantage that it requires some lead-time for training.

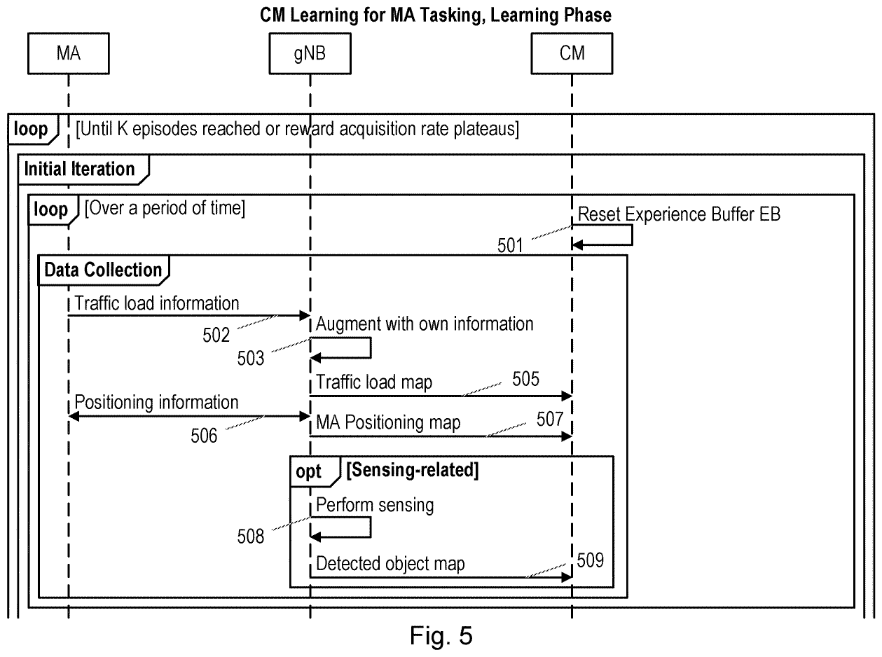

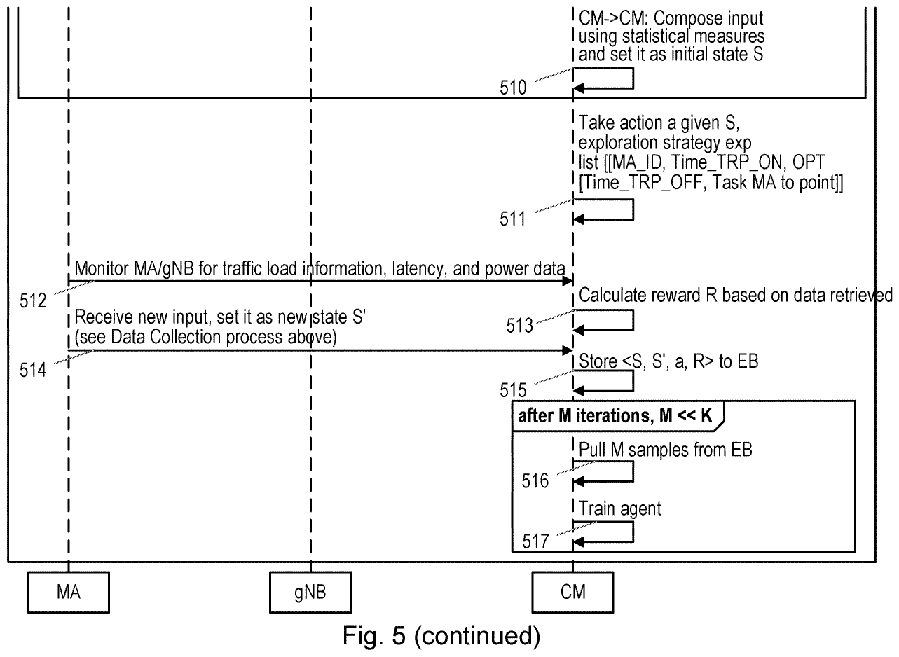

FIG. 5 illustrates an exemplary learning process for the control module 101/111/201. FIG. 5 shows operations and interactions by a MA, gNB and the control module (CM). A deep reinforcement learning approach is useful as it can adapt to changing conditions in the communication network, but also to the unique patterns that different networks may have. As such, the control module 101/111/201 has a neural network that is trained to solve a Markov decision process (MDP). In MDP, an agent takes an action against an environment and gets rewarded for that action by a scalar, also known as reward. The goal for the agent is to learn to take the actions that yield the highest reward in every environmental state, i.e. to learn the optimal policy. To formalise the learning problem, state, action and reward are defined.

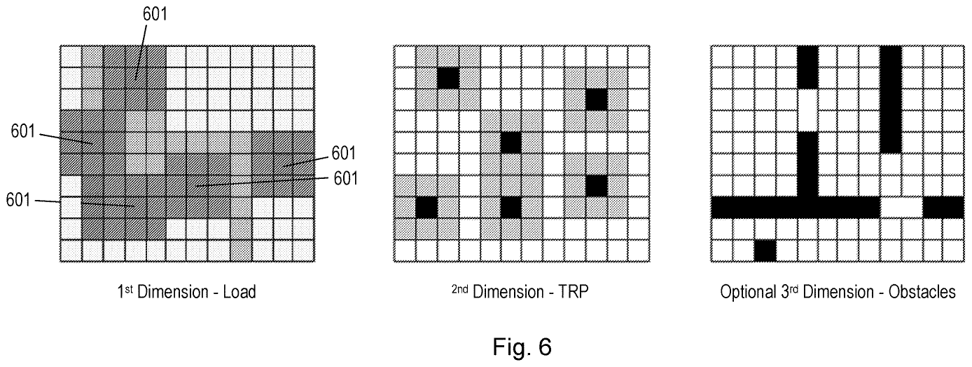

State: the state is the input to the control module 101/111/201 shown in FIG. 2. A first part of the state can be the load, presence and, optionally, sensing map (or simply “map”). This part of the input can be represented as a 3-dimensional (3D) matrix that maps demand and presence of MAs, as shown in FIG. 6.

The matrix is split into cells, each cell representing certain geographical area. A reference point can be used to indicate the distance of the different elements in the map. The distributed control module embodiment can use the gNB 112 the control module is responsible for as a reference point, whereas in the centralised control module deployment, any of the gNBs 102 can be used as a reference point.

The first dimension shows the load at different cells. This load can be measured from the MAs currently deployed, in addition to the gNB itself, using directional beams and measuring performance monitoring (PM) counters such as number of active user equipments served at the cell, data traffic volume on the uplink and/or downlink interfaces as well as potential prioritised policies (e.g. UEs with a Quality Class Identifier (QCI) or quality flow identifier (QFI) lower than 9), etc.

The second dimension shows a presence of MAs in a cell, that are characterised by their status (ON and serving (e.g. a UE), or OFF and available for tasking). In some implementations, the MAs have fixed trajectories in the area, whereas in other implementations the MAs can be tasked to move to a specific point or along a specific path/route. The MAs may be UE themselves, and can be located using any type of positioning technology, including for example technologies such as 5G location services (LCS), as specified in the 3^{rd} Generation Partnership Project (3GPP) TS 23.273, “5G System Location Services (LCS)”.

The third dimension shows the presence of obstacles that may degrade the signal or block the route of MAs. Such obstacles can be learned using Joint Communication and Sensing (JCAS), or similar technologies. This is an optional dimension and can help the control module to task the correct MAs to missions. This dimension may also contain information about the obstacles such as their composition, as well as whether they are stationary or mobile.

As illustrated in FIG. 6, the map can be qualitative-in the first dimension for example the regions 601 can represent high load, which in turn can be measured as a function of total active UE and aggregate throughput. In another embodiment, each cell could contain a vector of raw values, instead of a qualitative measurement. In another embodiment, each cell does not represent instantaneous values, but instead average values sampled over a period in the form of a statistical measure (e.g., average, probability value distribution, etc.).

Another part of the input is the predicted utilisation and total capacity of the MA device. The capacity can use metrics such as Floating Point Operations Per Second (FLOPS) for computation, GigaBytes (GB) for memory, spectrum range and radio access technology (e.g., 2400-2460 Hz, 4^{th} Generation (4G)) for throughput. Utilisation can be given as a percentage of total capacity. An additional metric that could be used is power. As the MAs are mobile, they are potentially powered by batteries, and even when there is enough mission margin time-wise for an MA to function as a TRP, there may not be enough power. Therefore, metrics such as milliAmp hours (mAh) for the capacity and state of charge for the utilisation may be used.

Action: The action is the tasking of one or more MAs to a cell in the map where they are needed to cover the demand. For the algorithm to converge faster, a discrete action space can be considered, which can, for example, consist of the same number of cells as one dimension of the map, and in every cell a binary value of 0 and 1 is used to indicate a need for an MA to cover as a TRP or not. In a more complicated scenario, an integer value can be used to indicate either a qualitative assessment of the need, or even the number of MAs needed in the particular area. In addition, the action space can be multi-dimensional, indicating, for example, not only the need for an MA in a particular area, but also the duration.

Reward: A reward could be a normalised scalar between 0 and 1, the higher the better. A formalisation could be the total served throughput to total requested throughput ratio. More metrics can be added and normalised such as latency and power consumption.

The training process is iterative, the control module agent taking an action of MA tasking using a strategy of exploration and exploitation. A common strategy is epsilon greedy, in which the agent initially explores the action space for a given state, taking random actions, then getting a reward and the next state. The 4-tuple of previous/next state, action and reward can be stored in an experience buffer (EB) and eventually the agent trains its model using data from this experience buffer. In later iterations, the agent may take an action using its trained model, and then a random action, as the agent gets better at learning to predict future demand and tasking of MAs to cover this demand.

Referring to FIG. 5 in more detail, at step 501 the control module resets (e.g. empties) its experience buffer (EB).

A data collection process is performed by the MA, gNB and control module that includes the MA providing traffic load information (502) to the gNB, the gNB augmenting the traffic load information with its own relevant information (step 503) and sending a traffic load map 505 to the control module.

The data collection process also includes the MA and/or gNB obtaining or determining positioning information 506 for the MA, and the gNB provides a MA positioning map 507 to the control module.

Optionally, the data collection process includes an obstacle/object sensing process in which the gNB performs sensing (step 508), e.g. using JCAS techniques, and sends the map 509 of detected objects to the control module.

In step 510, the control module composes an input using statistical measures and sets it as an initial state S. For example, the control module can use an averaging function (e.g. weighted or simple averaging) for each of the measurements comprising the state (including positioning information).

In step 511, the control module takes an action a, given state S, according to an exploration strategy. This action a can be provided in the form a list, with entries in the list relating to individual MAs and indicating when those MAs should operate as a TRP, and optionally when they should stop operating as a TRP.

The control module then monitors the MA(s) and gNB for new traffic load information, latency information and/or power data (step 512).

In step 513 the control module calculates a reward R relating to action a based on the information received in step 512.

In step 514 the control module receives new input information (e.g. traffic load information, positioning information, detected object information, etc.) and sets it as an updated state S′. In step 515 the 4-tuple of the original state S, updated state S′, action a and reward R are stored in the experience buffer.

After M iterations of steps 511-515, in step 516 the M samples (4-tuples) are retrieved from the experience buffer and in step 517 the control module uses them to train the agent to select appropriate MA(s) to operate as TRPs.

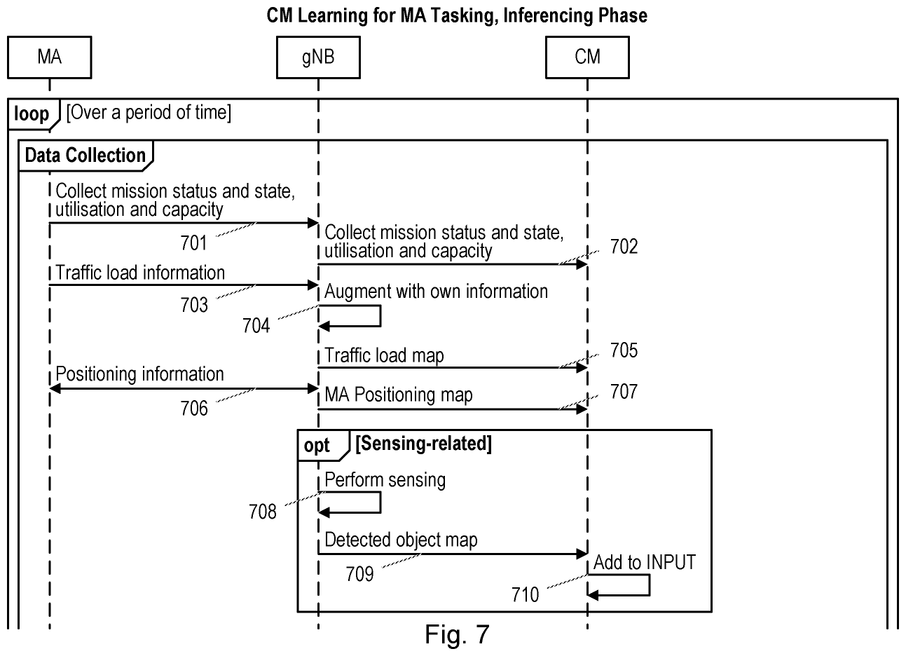

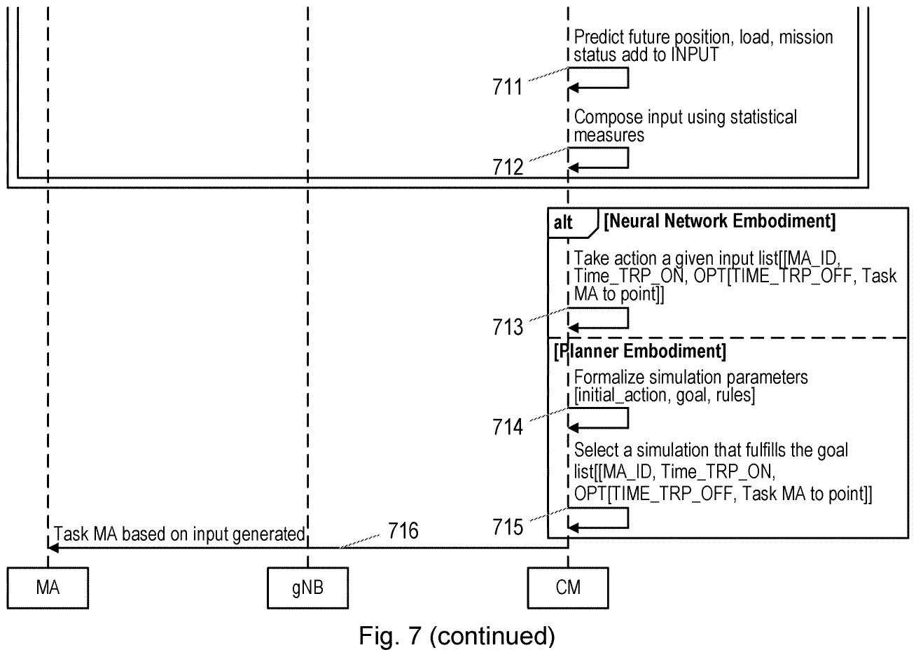

Once the agent is well trained, the normal operation (inferencing) processes can start, as shown by FIG. 7. FIG. 7 shows operations and interactions by a MA, gNB and the control module (CM). It will be appreciated that although the processes of training and inferencing, even though described herein as sequential, are not one-off. On the contrary, training can be repeated over time, e.g. periodically or based on an event such as the control module detecting a model drift, thus interleaving inferencing sessions with training sessions.

In FIG. 7, a data collection process is performed by the MA, gNB and control module that includes any one or more of: the gNB collecting from the MA any of mission status, state information, utilisation information, and/or capacity information (701), forwarding this information to the control module (step 702), the MA providing traffic load information (703) to the gNB, the gNB augmenting the traffic load information with its own relevant information (step 704), sending a traffic load map 705 to the control module, the MA and/or gNB obtaining or determining positioning information 706 for the MA, the gNB providing a MA positioning map 707 to the control module, the gNB performing an obstacle/object sensing process (step 708), e.g. using JCAS techniques, and sending the map 709 of detected objects to the control module. The control module adds the collected data/information to an INPUT to the inference process (step 710).

In step 711 the control module predicts any of a future MA position, load, mission status, etc. using any of the predictors 207-210 and adds these predictions to the INPUT.

In step 712, the control module composes the INPUT using statistical measures. For example, the control module gets an average or weighted average (in combination, or complemented, with other statistical techniques such as, for example, standard deviation or dispersion).

The next block in FIG. 7 includes steps for the alternative embodiments, i.e. the neural network-based embodiment, and the planner-based embodiment. Thus, in the neural network-based embodiment, in step 713 the control module determines and takes an action a given the INPUT determined in the previous steps. This action a can be provided in the form of a list, with entries in the list relating to individual MAs and indicating when those MAs should operate as a TRP, and optionally when they should stop operating as a TRP. Entries in the list can also indicate a position/location that the respective MA is to move to in order to operate as a TRP.

In the planner-based embodiment, in step 714 the control module formalises simulation parameters, e.g. an initial action, a goal and one or more rules, and in step 715 the control module selects a simulation that fulfils the goal, and executes the action(s) associated with that simulation. As above, the action(s) indicated by the simulation can be provided in the form of a list, with entries in the list relating to individual MAs and indicating when those MAs should operate as a TRP, and optionally when they should stop operating as a TRP. Entries in the list can also indicate a position/location that the respective MA is to move to in order to operate as a TRP.

Finally, in step/signal 716, the control module provides the determined actions to the MA(s), for example in the form of a suitable control signal.

FIG. 8 shows an example of a communication system 800 in accordance with some embodiments in which the techniques described herein can be utilised.

In the example, the communication system 800 includes a telecommunication network 802 that includes an access network 804, such as a radio access network (RAN), and a core network 806, which includes one or more core network nodes 808. The access network 804 includes one or more access network nodes, such as access network nodes 810a and 810b (which are interchangeably referred to as RAN network nodes 810 herein), or any other similar 3^{rd} Generation Partnership Project (3GPP) access node or non-3GPP access point (AP). Moreover, as will be appreciated by those of skill in the art, a RAN network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (RIC) (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies.

The access network nodes 810 facilitate direct or indirect connection of wireless devices (also referred to interchangeably herein as user equipment (UE)), such as by connecting UEs 812a, 812b, 812c, and 812d (one or more of which may be generally referred to as UEs 812) to the core network 806 over one or more wireless connections. The access network nodes 810 may be, for example, access points (APs) (e.g. radio access points), base stations (BSs) (e.g. radio base stations, Node Bs, evolved Node Bs (eNBs) and New Radio (NR) NodeBs (gNBs)). Although not shown in FIG. 8, one or more MA devices are present in the environment covered by the communication system 800. One or more of these MA devices may be UEs 812.

Unless otherwise indicated, the general term ‘network node’ as used herein refers to access network nodes 810 and core network nodes 808. The control module described herein, and in particular the techniques performed by the control module, can be part of the access network nodes 810 and/or the core network nodes 808.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The wireless devices/UEs 812 may be any of a wide variety of communication devices, including wireless devices arranged, configured, and/or operable to communicate wirelessly with the network nodes 810 and other communication devices. Similarly, the access network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the access network nodes 810 to one or more hosts, such as host 816. These connections may be direct or indirect via one or more intermediary networks or devices. In other examples, network nodes may be directly coupled to hosts. The core network 806 includes one more core network nodes (e.g. core network node 808) that are structured with hardware and software components. Features of these components may be substantially similar to those described with respect to the wireless devices/UEs, access network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the wireless devices/UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2^{nd} Generation (2G), 3^{rd} Generation (3G), 4^{th} Generation (4G), 5^{th} Generation (5G) standards, or any applicable future generation standard (e.g. 6^{th} Generation (6G)); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive Internet of Things (IoT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single-or multi-radio access technology (RAT) or multi-standard mode. For example, a UE may operate with any one or combination of Wi-Fi, NR (New Radio) and LTE, i.e. being configured for multi-radio dual connectivity (MR-DC), such as E-UTRAN (Evolved-UTRA (UMTS Terrestrial Radio Access) Network) New Radio—Dual Connectivity (EN-DC).

In the example illustrated in FIG. 8, the hub 814 communicates with the access network 804 to facilitate indirect communication between one or more UEs (e.g. UE 812c and/or 812d) and access network nodes (e.g. access network node 810b). In some examples, the hub 814 may be a controller, router, a content source and analytics node, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular if one or more of the UEs are low energy Internet of Things (IoT) devices.

The hub 814 may have a constant/persistent or intermittent connection to the network node 810b. The hub 814 may also allow for a different communication scheme and/or schedule between the hub 814 and UEs (e.g. UE 812c and/or 812d), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

FIG. 9 shows a wireless device or UE 900 in accordance with some embodiments.

As used herein, a UE refers to a device capable, configured, arranged and/or operable to communicate wirelessly with network nodes and/or other UEs. Examples of a wireless device/UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE. As noted above, a UE 900 can operate as, or be, a mobile antenna (MA) device as described herein.

A wireless device/UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g. a smart sprinkler controller). Alternatively, a UE may represent a device that is not intended for sale to, or operation by, an end user but which may be associated with or operated for the benefit of a user (e.g. a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g. in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs). The processing circuitry 902 may be operable to provide, either alone or in conjunction with other UE 900 components, such as the memory 910, to provide UE 900 functionality. For example, the processing circuitry 902 may be configured to cause the UE 902 to perform the methods as described with reference to FIG. 3 or 4.

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g. a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g. an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a Universal Subscriber Identity Module (USIM) and/or integrated SIM (ISIM), other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g. another UE or a network node in an access network). Each transceiver may include a transmitter 918 and/or a receiver 920 appropriate to provide network communications (e.g. optical, electrical, frequency allocations, and so forth). Moreover, the transmitter 918 and receiver 920 may be coupled to one or more antennas (e.g. antenna 922) and may share circuit components, software or firmware, or alternatively be implemented separately.

In some embodiments, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) or other Global Navigation Satellite System (GNSS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g. once every 15 minutes if it reports the sensed temperature), random (e.g. to even out the load from reporting from several sensors), in response to a triggering event (e.g. when moisture is detected an alert is sent), in response to a request (e.g. a user initiated request), or a continuous stream (e.g. a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an IoT device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

It will be appreciated that in implementations where a MA device is not itself a UE, the MA device can comprise one or more similar components to that of the UE 900 described above and shown in FIG. 9. In particular, such a MA device can comprise at least an antenna 922 and communication interface 912 as described above to enable the MA device to operate as a TRP (i.e. to receive signals and to retransmit those signals). An MA device may also comprise any of a power source 908 as described above, a memory 910 as described above, processing circuitry 902 as described above, or simplified processing circuitry given the lower processing requirements of the MA device.

FIG. 10 shows an access network node 1000 or RAN network node 1000 in accordance with some embodiments. As noted above, the control module described herein can be implemented in access network node 1000 or RAN network node 1000, or the access network node 1000 or RAN network node 1000 can otherwise perform the control module techniques described herein.

As used herein, access network node or RAN network node refers to equipment capable, configured, arranged and/or operable to communicate directly or indirectly with a UE and/or with other RAN network nodes or equipment or core network nodes, in a telecommunication network. Examples of access network nodes include, but are not limited to, access network nodes such as APs (e.g. radio access points), base stations (BSs) (e.g. radio base stations, Node Bs, evolved Node Bs (eNBs) and NR NodeBs (gNBs)), Open RAN (O-RAN) nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A RAN network node may also include one or more (or all) parts of a distributed radio base station such as centralized digital units, distributed units (e.g., in an O-RAN access node), and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of access network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The RAN network node 1000 includes processing circuitry 1002, a memory 1004, a communication interface 1006, and a power source 1008, and/or any other component, or any combination thereof. The RAN network node 1000 may be composed of multiple physically separate components (e.g. a NodeB component and a RNC component, or a BTS component and a BSC component, etc.), which may each have their own respective components. In certain scenarios in which the RAN network node 1000 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the RAN network node 1000 may be configured to support multiple radio access technologies (RATs). In such embodiments, some components may be duplicated (e.g. separate memory 1004 for different RATs) and some components may be reused (e.g. a same antenna 1010 may be shared by different RATs). The RAN network node 1000 may also include multiple sets of the various illustrated components for different wireless technologies integrated into RAN network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within RAN network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other RAN network node 1000 components, such as the memory 1004, to provide network node 1000 functionality. For example, the processing circuitry 1002 may be configured to cause the RAN network node to perform the methods as described with reference to FIG. 3.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the RAN network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signalling and/or data between network nodes, the access network, the core network, and/or a UE. As illustrated, the communication interface 1006 comprises port(s)/terminal(s) 1016 to send and receive data, for example to and from a network over a wired connection.

The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the access network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the RAN network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of RAN network node 1000 in a form suitable for the respective components (e.g. at a voltage and current level needed for each respective component). The power source 1008 may further comprise, or be coupled to, power management circuitry to supply the components of the network node 1000 with power for performing the functionality described herein. For example, the RAN network node 1000 may be connectable to an external power source (e.g. the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the RAN network node 1000 may include additional components beyond those shown in FIG. 10 for providing certain aspects of the network node's functionality, including any of the functionality described herein and/or any functionality necessary to support the subject matter described herein. For example, the RAN network node 1000 may include user interface equipment to allow input of information into the RAN network node 1000 and to allow output of information from the RAN network node 1000. This may allow a user to perform diagnostic, maintenance, repair, and other administrative functions for the RAN network node 1000.

FIG. 11 shows a core network node 1100 in accordance with some embodiments. As noted above, the control module described herein can be implemented in a core network node 1100, or the core network node 1100 can otherwise perform the control module techniques described herein.

As used herein, core network node refers to equipment capable, configured, arranged and/or operable to communicate directly or indirectly with a UE and/or with other core network nodes or equipment or RAN network nodes, in a telecommunication network. The core network node 1100 may be operable as a core network node, a core network function or, more generally, a core network entity, such as the core network node 808 described above with respect to FIG. 8). Examples of core network nodes in this context include core network entities such as one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The core network node 1100 includes processing circuitry 1102, a memory 1104, a communication interface 1106, and a power source 1108, and/or any other component, or any combination thereof. The core network node 1100 may be composed of multiple physically separate components, which may each have their own respective components. In certain scenarios in which the core network node 1100 comprises multiple separate components, one or more of the separate components may be shared among several core network nodes.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other core network node 1100 components, such as the memory 1104, core network node 1100 functionality. For example, the processing circuitry 1102 may be configured to cause the network node to perform the methods as described with reference to FIG. 3.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the core network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signalling and/or data between a core network node, access network node(s), and/or UE.

The power source 1108 provides power to the various components of core network node 1100 in a form suitable for the respective components (e.g., at a voltage and current level needed for each respective component). The power source 1108 may further comprise, or be coupled to, power management circuitry to supply the components of the core network node 1100 with power for performing the functionality described herein. For example, the core network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the core network node 1100 may include additional components beyond those shown in FIG. 11 for providing certain aspects of the core network node's functionality, including any of the functionality described herein and/or any functionality necessary to support the subject matter described herein. For example, the core network node 1100 may include user interface equipment to allow input of information into the core network node 1100 and to allow output of information from the core network node 1100. This may allow a user to perform diagnostic, maintenance, repair, and other administrative functions for the core network node 1100.

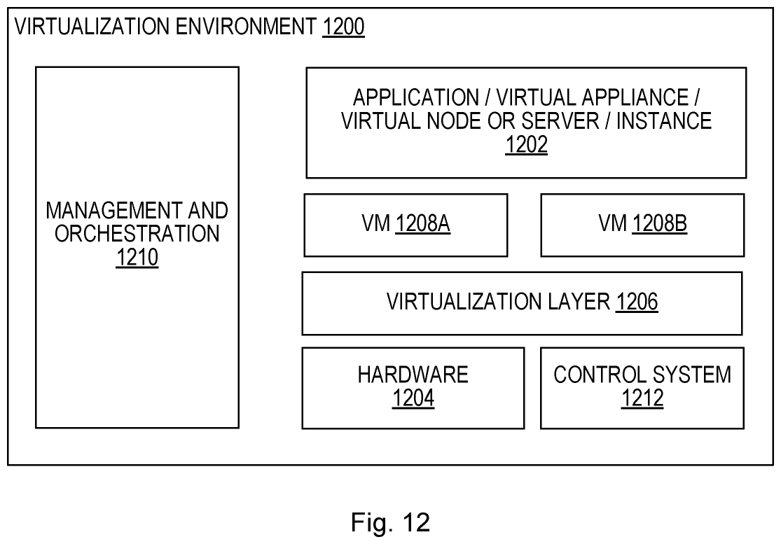

FIG. 12 is a block diagram illustrating a virtualization environment 1200 in which functions implemented by some embodiments may be virtualized. In particular, the control module described herein can be virtualized by virtualization environment 1200.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as an access network node, a wireless device/UE, or a core network node. Further, in embodiments in which the virtual node does not require radio connectivity (e.g. a core network node), then the node may be entirely virtualized. In some embodiments, the virtualization environment 1200 includes components defined by the Open-RAN (O-RAN) Alliance, such as an O-Cloud environment orchestrated by a Service Management and Orchestration Framework via an O-2 interface.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 1212 which may alternatively be used for communication between hardware nodes and radio units.

Although the computing devices described herein (e.g. UEs, MAs, RAN network nodes, core network node) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1-17. (canceled)

18. A computer-implemented method of forming a Distributed-Multiple Input, Multiple Output (D-MIMO) arrangement in a communication network, the method comprising:
obtaining movement information relating to movement of mobile antenna (MA) devices in the communication network;
determining, from the movement information, one or more of the MA devices to be operated as respective Transmission and/or Reception Points (TRPs) in the D-MIMO arrangement; and
sending a first control signal to each determined MA device, instructing the determined MA device to operate as a respective TRP in the D-MIMO arrangement.

19. The method according to claim 18, wherein the method further comprises:
estimating a traffic demand; and
wherein the step of determining is performed in response to the estimated traffic demand.

20. The method according to claim 19, wherein the step of determining is performed responsive to the estimated traffic demand being above a threshold value.

21. The method according to claim 18, wherein the first control signal sent to each determined MA indicates a respective time at which the determined MA device is to operate as a respective TRP in the D-MIMO arrangement.

22. The method according to claim 18, wherein the method further comprises:
predicting a future traffic demand; and
wherein the step of determining is performed in response to the predicted future traffic demand, and wherein the first control signal sent to each determined MA device indicates a respective time related to the predicted future traffic demand at which the determined MA device is to operate as a respective TRP in the D-MIMO arrangement.

23. The method according to claim 18, wherein the first control signal further instructs each determined MA device to move to a respective location or move along a respective path in order to operate as a respective TRP in the D-MIMO arrangement.

24. The method according to claim 23, wherein the method further comprises determining at least one of:
a respective location for each determined MA device to move to; and
a respective path each determined MA device to move along based on a prediction of one or more locations at which a respective TRP is useful for the D-MIMO arrangement.

25. The method according to claim 18, wherein the first control signal sent to each determined MA device instructs the determined MA device to operate as a respective TRP for the D-MIMO arrangement when at one or more respective locations and/or when moving along a respective path.

26. The method according to claim 18, wherein the movement information comprises any of: planned movement routes for respective ones of the MA devices; one or more waypoints that respective ones of the MA devices are to move to over time; predicted movement trajectories for respective ones of the MA devices that are predicted based on current movements of the respective ones of the MA devices; or timing information relating to movement of respective ones of the MA devices.

27. The method according to claim 18, wherein the method further comprises:
sending a second control signal to each determined MA device to instruct the determined MA device to stop operating as a respective TRP in the D-MIMO arrangement.

28. The method according to claim 27, wherein the second control signal is sent in response to an estimated traffic demand.

29. A method of operating a first mobile antenna (MA) device that includes an antenna and a communication interface for selective operation of the first MA device as a Transmission and/or Reception Point (TRP), the method comprising:
receiving a first control signal, wherein the first control signal instructs the first MA device to operate as a respective TRP in a Distributed-Multiple Input, Multiple Output (D-MIMO) arrangement with respect to at least one of: the first MA device being at one or more respective locations, or the first MA device moving along a respective path; and
operating the first MA device as a respective TRP in the D-MIMO arrangement responsive to at least one of: the first MA device being at one of the one or more respective locations or the first MA device moving along the respective path.

30. The method according to claim 29, wherein the first control signal further indicates a time at which the first MA device is to operate as a respective TRP in the D-MIMO arrangement, and wherein the method includes the first MA device operating as a respective TRP in the D-MIMO arrangement further according to the indicated time.

31. A control module configured for operation in a communication network, the control module comprising:
a communication interface; and
processing circuitry configured to:
obtain movement information relating to movement of mobile antenna (MA) devices in the communication network;
determine, from the movement information, one or more of the MA devices to be operated as respective Transmission and/or Reception Points (TRPs) in a Distributed-Multiple Input, Multiple Output (D-MIMO) arrangement; and
send, via the communication interface, a first control signal for each determined MA device, instructing the determined MA device to operate as a respective TRP in the D-MIMO arrangement.

32. The control module according to claim 31, wherein the processing circuitry is configured to include in the first control signal for each determined MA device at least one of the following: one or more times at which the determined MA device is to operate as a respective TRP in the D-MIMO arrangement, one or more locations at which the determined MA device is to operate as a respective TRP in the D-MIMO arrangement, or a movement path along which the determined MA device is to operate as a respective TRP in the D-MIMO arrangement.

33. A mobile antenna (MA) device configured for operation in a communication network, the MA device comprising:
an antenna and a communication interface configured for use of the MA device as a Transmission and/or Reception Point (TRP); and
control circuitry configured to receive a first control signal via the antenna and communication interface and to operate the MA device as a respective TRP in a Distributed-Multiple Input, Multiple Output (D-MIMO) arrangement according to the first control signal, which indicates at least one of:
one or more times during which the MA device is to be operated as a respective TRP in the D-MIMO arrangement;
one or more locations at which the MA device is to be operated as a respective TRP in the D-MIMO arrangement; or
a movement path along which the MA device is to be operated as a respective TRP in the D-MIMO arrangement.
